(19) United States
(12) Patent Application Publication
(10) Pub. No.: US 2024/0008547 A1
(43) Pub. Date: Jan. 11, 2024

(54) INDUCTION HEATING ELEMENT FOR AEROSOL-GENERATING DEVICE WITH THERMALLY DEFORMABLE SUSCEPTOR

(71) Applicant: Philip Morris Products S.A., Neuchatel (CH)

(72) Inventors: Rui Nuno Rodrigues Alves BATISTA, Morges (CH); Ricardo CALI, Mannheim (DE); Oleg MIRONOV, Cudrefin (CH)

(73) Assignee: Philip Morris Products S.A., Neuchatel (CH)

(21) Appl. No.: 18/253,134

(22) PCT Filed: Nov. 19, 2021
(86) PCT No.: PCT/EP2021/082250

§ 371 Date: May 16, 2023

(30) Foreign Application Priority Data
Nov. 24, 2020 (EP) 20209516.2

(51) Int. Cl. A24F 40/465; H05B 6/10; A24F 40/20; A24D 1/00; A24D 1/20

(52) U.S. Cl. CPC A24F 40/465; H05B 6/105; A24F 40/20; A24D 1/002; A24D 1/20

(57) ABSTRACT

An aerosol-generating device is provided, including: a cavity configured to receive an aerosol-generating article including an aerosol-forming substrate; and an induction heating element including a susceptor configured to heat, the susceptor being arranged as multiple elongate elements forming a hollow tubular arrangement with gaps between individual elongate elements, the susceptor including a thermally deformable element arranged in the cavity, and the thermally deformable element being configured to thermally deform during a heating operation to contact and hold the aerosol-generating article received in the cavity during a heating operation. A system including the aerosol-generating device and an aerosol-generating article is also provided.

The present invention relates to an aerosol-generating device.

It is known to provide an aerosol-generating device for generating an inhalable vapor. Such devices may heat aerosol-forming substrate to a temperature at which one or more components of the aerosol-forming substrate are volatilised without burning the aerosol-forming substrate. Aerosol-forming substrate may be provided as part of an aerosol-generating article. The aerosol-generating article may have a rod shape for insertion of the aerosol-generating article into a cavity, such as a heating chamber, of the aerosol-generating device. A heating element may be arranged in or around the heating chamber for heating the aerosol-forming substrate once the aerosol-generating article is inserted into the heating chamber of the aerosol-generating device. The cavity has to be configured to enable insertion of the aerosol-generating article. At the same time, the aerosol-generating article has to be securely held within the cavity during operation of the aerosol-generating device.

It would be desirable to have the heating element enabling insertion of the aerosol-generating article into the cavity. It would be desirable to have the heating element securely holding the aerosol-generating article in the cavity during operation of the aerosol-generating device. It would be desirable to have an aerosol-generating device enabling insertion of the aerosol-generating article into the cavity. It would be desirable to have the aerosol-generating device securely holding the aerosol-generating article in the cavity during operation of the aerosol-generating device. It would be desirable to have a system comprising an aerosol-generating device and an aerosol-generating article in which insertion of the aerosol-generating article into the cavity of the aerosol-generating device is enabled. It would be desirable to have a system comprising an aerosol-generating device and an aerosol-generating article in which the aerosol-generating article is securely held within the cavity of the aerosol-generating device when the aerosol-generating device is operated. It would be desirable if the inhalable vapor could further be modified to the user's desire.

According to an embodiment of the invention there is provided an aerosol-generating device that may comprise a cavity for receiving an aerosol-generating article comprising aerosol-forming substrate and may comprise a heating element. The heating element may be an induction heating element. The heating element may comprise a susceptor configured for heating. The susceptor may comprise a thermally deformable element. The thermally deformable element may be arranged in the cavity. The thermally deformable element may be configured to thermally deform during a heating operation to contact and hold the aerosol-generating article received in the cavity during the heating operation.

According to an embodiment of the invention there is provided an aerosol-generating device comprising a cavity for receiving an aerosol-generating article comprising aerosol-forming substrate and a heating element. The heating element is an induction heating element. The heating element comprises a susceptor configured for heating. The susceptor comprises a thermally deformable element. The thermally deformable element is arranged in the cavity. The thermally deformable element is configured to thermally deform during a heating operation to contact and hold the aerosol-generating article received in the cavity during the heating operation.

By providing the susceptor comprising a thermally deformable element, the susceptor can deform during a heating operation. The deformation of the susceptor may be utilized. Particularly, an aerosol-generating article may be held by the susceptor due to the deformation of the susceptor during operation. Thereby, loosening of the aerosol-generating article during a heating operation may be prevented. Further, the heating efficiency may be improved due to a closer contact between the susceptor and the aerosol-generating article.

The thermally deformable element may be made from bimetal. By utilizing a bimetal, the thermally deformable element may deform when heated. The bimetal may be configured to convert a temperature change to a deformation of the bimetal. The bimetal may comprise two metals joined together. The two metals may have different coefficients of thermal expansion leading to the deformation during heating. The two metals of the bimetal may be arranged such that the deformation during heating happens in the direction of the aerosol generating article. The metal with the lower coefficient of thermal expansion may be placed closer to the aerosol generating article. In this way, the thermally deformable element comes closer to the aerosol-generating article during the heating operation.

The thermally deformable element may comprise a bimetal strip. The bimetal strip may be elongate. The longitudinal axis of the bimetal strip may be parallel to the longitudinal axis of the cavity. The bimetal strip may comprise two elongate metals joined together. The joining axis of the two metals may be parallel or along the longitudinal axis of the bimetal strip. The bimetal strip may have a rectangular cross-section. However, other cross-sections of the bimetal strip are possible such as a square, circular or elliptical cross-section.

The susceptor may be made from bimetal. In this case, the susceptor has a double functionality. The first functionality of the susceptor may be to be heated during a heating operation. The second functionality of the susceptor may be a deformation during heating. Particularly preferred, the susceptor may be the thermally deformable element.

The susceptor may comprise a first material and a second material. The first material may have a lower thermal coefficient of thermal expansion than the second material. The first material may be a first metal. The second material may be a second metal. The first material may be different from the second material. Particularly, the first metal may be different from the second metal.

The first material and second materials may be provided as layers adjacent each other.

The first material and the second material may extend along the full length of the susceptor. Alternatively, the first material may extend along the full length of the susceptor while the second material only extends along parts of the susceptor of vice versa. For example, the second material may only be arranged in the middle portion of the susceptor. As a further alternative, the first material and the second material may be arranged in intermittent sections along the length of the susceptor. In all of these cases, a remaining part of the susceptor may be provided from one or both of the first material on the second material. Alternatively, the remaining part of the susceptor may be provided from a third material. The remaining part of the susceptor may be one or both of a distal part or a proximal part of the susceptor. The third material may be chosen as a material that is not heated when subjected to an alternating magnetic field. In other words, the third material may not be a susceptor material. However, if heating also adjacent the third material is desired, the third material may also be a susceptor material.

The susceptor, preferably the thermally deformable element of the susceptor, may be arranged as multiple elongate elements.

The multiple susceptors may be arranged parallel to a longitudinal axis of the cavity of the aerosol generating device. The multiple susceptors may be arranged to at least partly receive the aerosol-generating article. The multiple susceptors may be arranged to form the cavity for receiving the aerosol-generating article. The multiple susceptors may be arranged in the cavity for receiving the aerosol-generating article. The multiple susceptors may be arranged so that all of the susceptors are deformed in an inwards direction when heated.

The susceptor, preferably the thermally deformable element of the susceptor, may be arranged as multiple elongate elements forming a hollow tubular arrangement with gaps between the individual elongate elements.

The gaps between the individual elongate susceptors may enable a lateral airflow into the aerosol-generating article. The hollow tubular arrangement may form the cavity for receiving the aerosol-generating article or may be placed in the cavity. During heating, all of the individual susceptors may deformed towards the inside of this hollow tubular arrangement. This may lead to securely holding of the aerosol-generating article and to improving of heating efficiency.

Each of the multiple elongate elements may comprise a first end and an opposite second end. One or both of each of the first ends and each of the second ends of the multiple elongate elements may be connected with each other, preferably via a supporting ring.

In other words, the multiple susceptors may be connected to each other at one side. This connection may be at a base of the cavity formed by the susceptors. The connection at the base may be facilitated by directly connecting the susceptors with the base. The base may be part of the aerosol-generating device as described herein. Alternatively, the connection at the base may be facilitated by the supporting ring. The supporting ring may be connected with the aerosol generating device, preferably at the base of the cavity. Consequently, the susceptors may be connected with each other at the base of the cavity into which the aerosol-generating article can be inserted. Alternatively, the susceptors may be connected with each other adjacent to an opening of the cavity. This connection may be facilitated by a supporting ring. The supporting ring may form the opening of the cavity. Alternatively, the supporting ring may be arranged adjacent the opening of the cavity or surround the opening of the cavity. As a further alternative, the susceptors may be connected adjacent the opening of the cavity and at the base of the cavity.

When the susceptors are connected to each other at the base of the cavity, the susceptors adjacent the opening of the cavity are preferably not connected with each other. This may lead to a slight funnel shape of the susceptors. In other words, the inner diameter of the hollow tubular arrangement may be reduced towards the base of the cavity. This may aid insertion of the aerosol generating article into the cavity. During operation, inner diameter of the hollow tubular arrangement particularly adjacent the opening of the hollow tubular arrangement may be reduced so that the aerosol-generating article is securely held.

If the susceptors are attached with each other at the base of the cavity and adjacent the opening of the cavity, a middle portion of the susceptors may be utilized for holding the aerosol-generating article during operation. In this case, the inner diameter of the hollow tubular arrangement at the base of the cavity and adjacent the opening of the cavity may be slightly larger than the outer diameter of the aerosol-generating article for the whole time of the operation and before and after operation due to the connection of the susceptors. However, at the middle portion of the susceptors, the susceptors may be deformable towards the inner of the hollow tubular arrangement. During operation, the susceptors may thus deform similar to an hourglass shape to securely hold the aerosol-generating article. During operation, the inner diameter of the susceptors at the middle portion of the susceptors may be slightly smaller than the outer diameter of the aerosol-generating article.

Adjacent the opening of the cavity, the susceptors may be flared. The susceptors are preferably flared outwards. The flaring of the susceptors may make insertion of the aerosol-generating article into the cavity easier. The flared shape of the susceptors may guide the aerosol-generating article during insertion of the aerosol-generating article into the cavity.

The hollow tubular arrangement of the susceptors may have an inner diameter that is slightly larger than the outer diameter of the aerosol-generating article to be received in the cavity. In this way, the aerosol-generating article can easily be inserted into the cavity. During operation, the susceptors may deform as described herein. The deformation may lead to a reduction of the inner diameter of the hollow tubular arrangement. The reduction of the inner diameter of the hollow tubular arrangement may be such that the inner diameter of the deformed hollow tubular arrangement may be slightly smaller than the outer diameter of the aerosol-generating article. In this way, the aerosol-generating article is securely held within the hollow tubular arrangement during a heating operation.

After the heating operation, the thermally deformable element of the susceptor may be configured to return to the initial shape. The return to the initial shape may be due to a cooling of the thermally deformable element to an ambient temperature. The thermally deformable element may have ambient temperature before the heating operation and at some time after the heating operation. Consequently, the aerosol-generating article can be easily removed after the heating operation, when the thermally deformable element returns to its initial shape.

The aerosol-generating device may further comprise an induction coil for generating an alternating magnetic field to heat the susceptor of the heating element.

The induction coil may at least partly or fully surround the cavity. The induction coil is preferably configured as a helical coil.

The cavity may be tubular. The hollow tubular arrangement of the susceptors or the thermally deformable elements of the susceptors may be arranged at least partly surrounding or at least partly forming the cavity.

The first ends of the multiple elongate elements may be connected with each other via a supporting ring. The second ends of the multiple elongate elements may be fixed to a base of the cavity.

The base of the cavity may be arranged at a distal end of the cavity, and the supporting ring may be arranged at a proximal end of the cavity.

The first material with the lower thermal coefficient of thermal expansion may be arranged facing the cavity, and the second material may be arranged facing away from the cavity.

The invention further relates to a system comprising an aerosol-generating device as described herein and an aerosol-generating article comprising aerosol-forming substrate as described herein.

The thermally deformable element of the susceptor may be arranged to enable insertion of the aerosol-generating article into the cavity, when the heating element is not operated. The thermally deformable element of the susceptor may be configured to thermally deform and thereby hold the aerosol-generating article in the cavity, when the heating element is operated.

The aerosol-generating article may comprise one or more breakable capsules comprising one or more active agents. The one or more breakable capsules may be arranged adjacent to the thermally deformable element when the aerosol-generating article is received in the cavity such that the capsule may be broken and the one or more active agents released when the heating element is operated and the thermally deformable element of the susceptor is thermally deformed.

The aerosol-generating article may comprise a substrate portion containing an aerosol-forming substrate. The aerosol-generating article furthermore may comprise a capsule portion containing a carrier material, wherein one or more breakable capsules may be embedded in the carrier material. The one or more breakable capsules may contain one or more active agents. At least parts of the one or more breakable capsules may be arranged at the outer surface of the aerosol-generating article.

Arranging the one or more breakable capsules at the outer surface of the aerosol-generating article may ease breaking the capsules, when the aerosol-generating article is received in the cavity of the aerosol-generating device.

Provided is also an aerosol-generating article which may comprise a substrate portion containing an aerosol-forming substrate. The aerosol-generating article furthermore may comprise a capsule portion containing a carrier material. One or more breakable capsules may be embedded in the carrier material. The one or more breakable capsules may contain one or more active agents. The capsule portion furthermore may contain at least one stiff element. the stiff element may be stiffer than the carrier material and the at least one stiff element may be configured for breaking the breakable capsules upon application of a pressure to the capsule portion.

The thermally deformable element of the aerosol-generating device may push the at least one stiff element, when the heating element is operated and the thermally deformable element of the susceptor is thermally deformed. The stiff element may break the one or more breakable capsules due to the external pressure from the thermally deformable element.

The at least one stiff element in the aerosol-generating article may be wedge-shaped. The at least one stiff element may contain edges for penetrating the one or more breakable capsules. The at least one stiff element may be made of plastic. The at least one stiff element may be arranged at the outer surface of the aerosol-generating article, in particular the outer surface of the capsule portion.

In particular, a plurality of stiff elements may be present in the capsule portion of the aerosol-generating particle. One breakable capsule may be concentrically surrounded by the plurality of stiff elements.

The at least one stiff element or the plurality of stiff elements may be arranged at the outer surface of the aerosol-generating article. Thus, it may be possible to break the capsule by applying pressure to the stiff elements, which then in turn will facilitate breaking the capsule.

The carrier material may be configured to resist pressure applied to the capsule portion. This may ensure that any pressure applied from the outside to the capsule portion is not absorbed by the carrier material, but leads to the breakage of the one or more breakable capsules.

The carrier material may have a higher density than the aerosol-forming substrate in the substrate portion. The higher density of the carrier material also may reduce or prevent any absorption of the pressure applied to the capsule portion by the carrier material, so that the one or more breakable capsules can easily be broken.

The carrier material may comprise one or more of cellulose acetate fibre, paper, porous polymer and charcoal. The cellulose acetate fiber may be cellulose acetate tow. The porous polymer may be porous resins, such as a phenyl-formaldehyde resin.

The carrier material may have a compressive strength of between 20 to 60 Megapascal (MPa), preferably 29 to 53 Megapascal.

The one or more active agents contained in the one or more breakable capsules may be solid or liquid. The one or more active agents may comprise a gel. The one or more active agents may be volatile. Containing volatile active agents in the one or more breakable capsules may ensure that the volatile agents do not evaporate before the aerosol-generating article is used.

The one or more active agents may be prone to react with atmospheric components, such as oxygen. Containing these sensitive active agents in the one or more breakable capsules may prevent any deterioration of the active agents before the aerosol-forming article is used.

The one or more active agents may comprise one or more of flavorants, nicotine and medications. For example, the one or more active agents may comprise flavorants oils, such as mint oil, menthol, nicotine oil or other flavorants.

As used herein, an ‘aerosol-generating device’ relates to a device that interacts with an aerosol-forming substrate to generate an aerosol. The aerosol-forming substrate may be part of an aerosol-generating article, for example part of a smoking article. An aerosol-generating device may be a smoking device that interacts with an aerosol-forming substrate of an aerosol-generating article to generate an aerosol that is directly inhalable into a user's lungs thorough the user's mouth. An aerosol-generating device may be a holder. The device may be an electrically heated smoking device. The aerosol-generating device may comprise a housing, electric circuitry, a power supply, a heating chamber and a heating element.

As used herein, the term ‘aerosol-generating article’ refers to an article comprising an aerosol-forming substrate that is capable of releasing volatile compounds that can form an aerosol. For example, an aerosol-generating article may be a smoking article that generates an aerosol that is directly inhalable into a user's lungs through the user's mouth. An aerosol-generating article may be disposable. The cavity of the aerosol-generating device may have an open end into which the aerosol-generating article is inserted. The open end may be a proximal end. The cavity may have a closed end opposite the open end. The closed end may be the base of the cavity. The closed end may be closed except for the provision of air apertures arranged in the base. The base of the cavity may be flat. The base of the cavity may be circular. The base of the cavity may be arranged upstream of the cavity. The open end may be arranged downstream of the cavity. The cavity may have an elongate extension. The cavity may have a longitudinal central axis. A longitudinal direction may be the direction extending between the open and closed ends along the longitudinal central axis. The longitudinal central axis of the cavity may be parallel to the longitudinal axis of the aerosol-generating device.

The cavity may be configured as a heating chamber. The cavity may have a cylindrical shape. The cavity may have a hollow cylindrical shape. The cavity may have a shape corresponding to the shape of the aerosol-generating article to be received in the cavity. The cavity may have a circular cross-section. The cavity may have an elliptical or rectangular cross-section. The cavity may have an inner diameter corresponding to the outer diameter of the aerosol-generating article.

An airflow channel may run through the cavity. Ambient air may be drawn into the aerosol-generating device, into the cavity and towards the user through the airflow channel. Downstream of the cavity, a mouthpiece may be arranged or a user may directly draw on the aerosol-generating article. The airflow channel may extend through the mouthpiece.

As used herein with reference to the present invention, the term ‘smoking’ with reference to a device, article, system, substrate, or otherwise does not refer to conventional smoking in which an aerosol-forming substrate is fully or at least partially combusted. The aerosol-generating device of the present invention is arranged to heat the aerosol-forming substrate to a temperature below a combustion temperature of the aerosol-forming substrate, but at or above a temperature at which one or more volatile compounds of the aerosol-forming substrate are released to form an inhalable aerosol.

The aerosol-generating device may comprise electric circuitry. The electric circuitry may comprise a microprocessor, which may be a programmable microprocessor. The microprocessor may be part of a controller. The electric circuitry may comprise further electronic components. The electric circuitry may be configured to regulate a supply of power to the heating element, particularly to the induction coil. Power may be supplied to the heating element continuously following activation of the aerosol-generating device or may be supplied intermittently, such as on a puff-by-puff basis. The power may be supplied to the heating element in the form of pulses of electrical current. The electric circuitry may be configured to monitor the electrical resistance of the heating element, and preferably to control the supply of power to the heating element dependent on the electrical resistance of the heating element.

The aerosol-generating device may comprise a power supply, typically a battery, within a main body of the aerosol-generating device. In one embodiment, the power supply is a Lithium-ion battery. Alternatively, the power supply may be a Nickel-metal hydride battery, a Nickel cadmium battery, or a Lithium based battery, for example a Lithium-Cobalt, a Lithium-Iron-Phosphate, Lithium Titanate or a Lithium-Polymer battery. As an alternative, the power supply may be another form of charge storage device such as a capacitor. The power supply may require recharging and may have a capacity that enables to store enough energy for one or more usage experiences; for example, the power supply may have sufficient capacity to continuously generate aerosol for a period of around six minutes or for a period of a multiple of six minutes. In another example, the power supply may have sufficient capacity to provide a predetermined number of puffs or discrete activations of the heating element.

As used herein, the term ‘aerosol-forming substrate’ relates to a substrate capable of releasing one or more volatile compounds that can form an aerosol. Such volatile compounds may be released by heating the aerosol-forming substrate. An aerosol-forming substrate may conveniently be part of an aerosol-generating article or smoking article.

The aerosol-forming substrate may be a solid aerosol-forming substrate. The aerosol-forming substrate may comprise both solid and liquid components. The aerosol-forming substrate may comprise a tobacco-containing material containing volatile tobacco flavour compounds which are released from the substrate upon heating. The aerosol-forming substrate may comprise a non-tobacco material. The aerosol-forming substrate may comprise an aerosol former that facilitates the formation of a dense and stable aerosol. Examples of suitable aerosol formers are glycerine and propylene glycol.

In a preferred embodiment, the aerosol generating article comprises a substrate portion with a breakable capsule next to the thermally deformable element of the susceptor, when the aerosol-generating article is inserted into the cavity of the aerosol-generating device. During operation, the breaking capsule is ruptured to release an active agent, when the thermally deformable element is deformed and presses against the breakable capsule.

As used herein, the terms ‘upstream’, ‘downstream’, ‘proximal’, ‘distal’, ‘front’ and ‘rear’, are used to describe the relative positions of components, or portions of components, of the aerosol-generating device in relation to the direction in which a user draws on the aerosol-generating device during use thereof.

As described herein, induction heating is utilized. For induction heating, the induction coil and the susceptor are provided. In general, a susceptor is a material that is capable of generating heat, when penetrated by an alternating magnetic field. When located in an alternating magnetic field. If the susceptor is conductive, then typically eddy currents are induced by the alternating magnetic field. If the susceptor is magnetic, then typically another effect that contributes to the heating is commonly referred to hysteresis losses. Hysteresis losses occur mainly due to the movement of the magnetic domain blocks within the susceptor, because the magnetic orientation of these will align with the magnetic induction field, which alternates. Another effect contributing to the hysteresis loss is when the magnetic domains will grow or shrink within the susceptor. Commonly all these changes in the susceptor that happen on a nano-scale or below are referred to as “hysteresis losses”, because they produce heat in the susceptor. Hence, if the susceptor is both magnetic and electrically conductive, both hysteresis losses and the generation of eddy currents will contribute to the heating of the susceptor. If the susceptor is magnetic, but not conductive, then hysteresis losses will be the only means by which the susceptor will heat, when penetrated by an alternating magnetic field. According to the invention, the susceptor may be electrically conductive or magnetic or both electrically conductive and magnetic. An alternating magnetic field generated by one or several induction coils heat the susceptor, which then transfers the heat to the aerosol-forming substrate, such that an aerosol is formed. The heat transfer may be mainly by conduction of heat. Such a transfer of heat is best, if the susceptor is in close thermal contact with the aerosol-forming substrate.

Below, there is provided a non-exhaustive list of non-limiting examples. Any one or more of the features of these examples may be combined with any one or more features of another example, embodiment, or aspect described herein.

Example A: Aerosol-generating device comprising:
a cavity for receiving an aerosol-generating article comprising aerosol-forming substrate, and
a heating element, wherein the heating element is an induction heating element, wherein the heating element comprises a susceptor configured for heating, wherein the susceptor comprises a thermally deformable element, wherein the thermally deformable element is arranged in the cavity, and wherein the thermally deformable element is configured to thermally deform during a heating operation to contact and hold the aerosol-generating article received in the cavity during the heating operation.

Example B: Aerosol-generating device according to Example A, wherein the thermally deformable element is made from bimetal.

Example C: Aerosol-generating device according to any of the preceding examples, wherein the thermally deformable element comprises a bimetal strip.

Example D: Aerosol-generating device according to any of the preceding examples, wherein the susceptor is made from bimetal.

Example E: Aerosol-generating device according to any of the preceding examples, wherein the susceptor comprises a first material and a second material, wherein the first material has a lower thermal coefficient of thermal expansion than the second material.

Example F: Aerosol-generating device according to Example E, wherein the first and second materials are provided as layers adjacent each other.

Example G: Aerosol-generating device according to any of the preceding examples, wherein the susceptor, preferably the thermally deformable element of the susceptor, is elongate.

Example H: Aerosol-generating device according to any of the preceding examples, wherein the susceptor, preferably the thermally deformable element of the susceptor, is arranged as multiple elongate elements.

Example I: Aerosol-generating device according to any of the preceding examples, wherein the susceptor, preferably the thermally deformable element of the susceptor, is arranged as multiple elongate elements forming a hollow tubular arrangement with gaps between the individual elongate elements.

Example J: Aerosol-generating device according to Example H or I, wherein each of the multiple elongate elements comprises a first end and an opposite second end, and wherein one or both of each of the first ends and each of the second ends of the multiple elongate elements are connected with each other, preferably via a supporting ring.

Example K: Aerosol-generating device according to any of the preceding examples, wherein the device further comprises an induction coil for generating an alternating magnetic field to heat the susceptor of the heating element.

Example L: Aerosol-generating device according to any of the preceding examples, wherein the cavity is tubular.

Example M: Aerosol-generating device according to any of the preceding examples, wherein the first ends of the multiple elongate elements are connected with each other via a supporting ring, and wherein the second ends of the multiple elongate elements are fixed to a base of the cavity.

Example N: Aerosol-generating device according to Example M, wherein the base of the cavity is arranged at a distal end of the cavity, and the supporting ring is arranged at a proximal end of the cavity.

Example O: Aerosol-generating device according to Examples 5 and any of the preceding examples, wherein the first material with the lower thermal coefficient of thermal expansion is arranged facing the cavity, and the second material is arranged facing away from the cavity.

Example P: System comprising an aerosol-generating device according to any of the preceding examples and an aerosol-generating article comprising aerosol-forming substrate.

Example Q: System according to Example P, wherein the thermally deformable element of the susceptor is arranged to enable insertion of the aerosol-generating article into the cavity, when the heating element is not operated, and wherein the thermally deformable element of the susceptor is configured to thermally deform and thereby contact and hold the aerosol-generating article in the cavity, when the heating element is operated.

Example R: System according to Example P or Q, wherein the aerosol-generating article comprises a capsule comprising an active agent, and wherein the capsule is arranged adjacent the thermally deformable element when the aerosol-generating article is received in the cavity such that the capsule is ruptured and the active agent released when the heating element is operated and the thermally deformable element of the susceptor is thermally deformed.

Features described in relation to one embodiment may equally be applied to other embodiments of the invention.

The invention will be further described, by way of example only, with reference to the accompanying drawings in which:

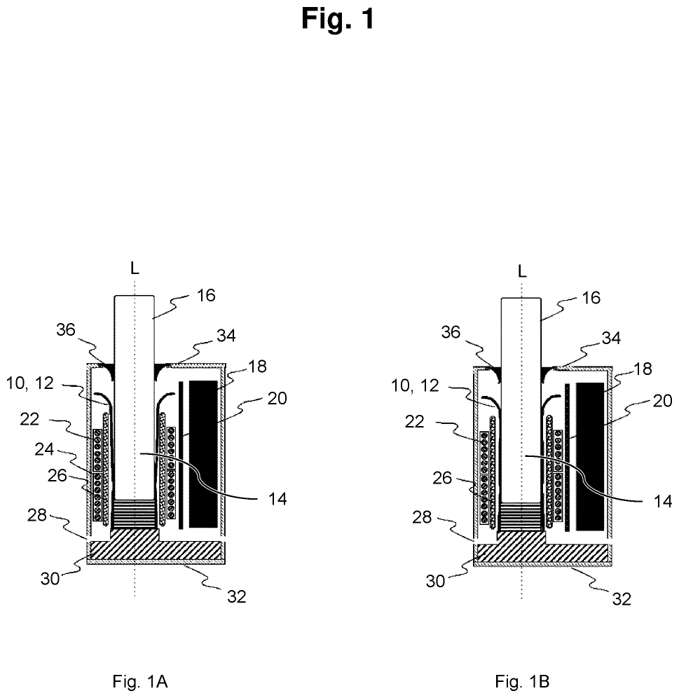

FIGS. 1A and 1B show an aerosol-generating system comprising an aerosol-generating device, an aerosol-generating article and heating element according to the present invention;

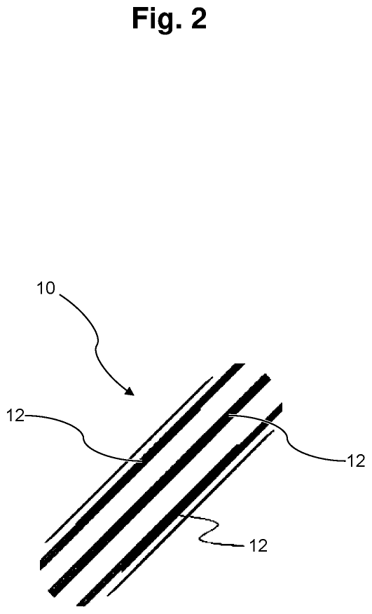

FIG. 2 shows the heating element in more detail;

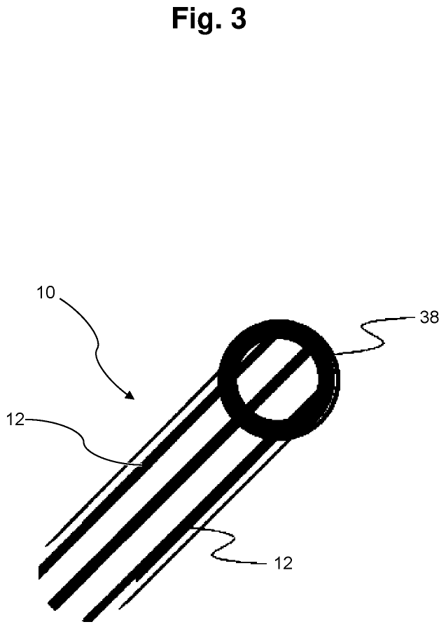

FIG. 3 shows a further embodiment of the heating element comprising a supporting ring;

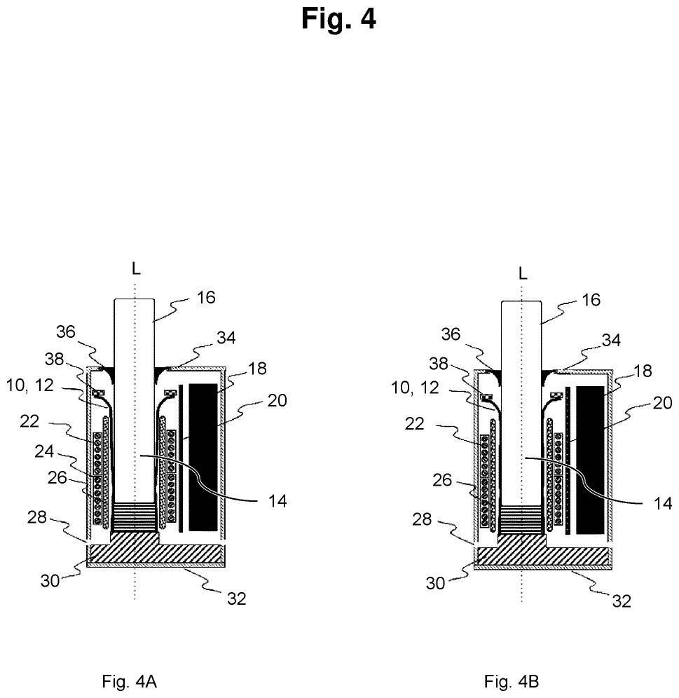

FIGS. 4A and 4B show the aerosol-generating system of FIG. 1 including the supporting ring as shown in FIG. 3; and

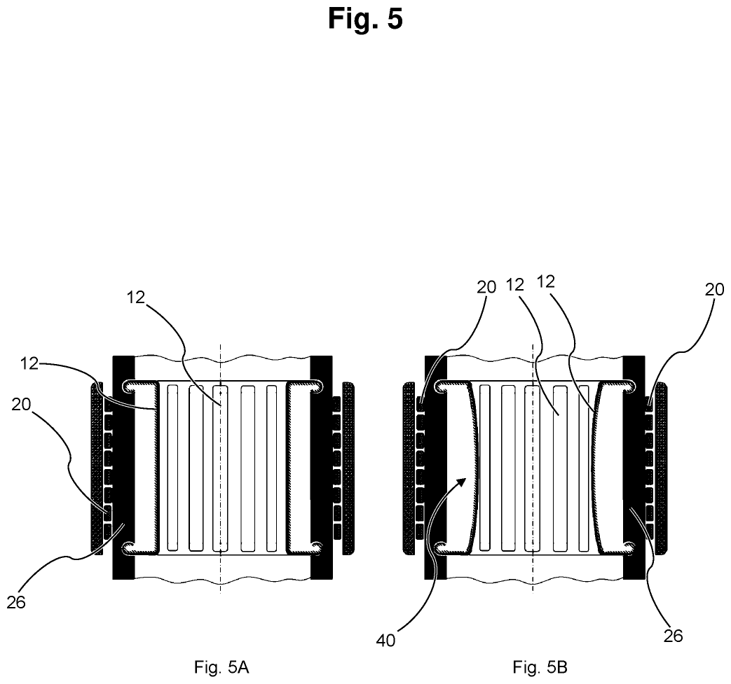

FIGS. 5A and 5B show a further embodiment of the heating element.

FIG. 1 shows an aerosol-generating system. The aerosol-generating system comprises an aerosol generating device and an aerosol-generating article 16. The aerosol-generating device comprises a heating element 10. The heating element 10 comprises a plurality of susceptors 12.

Each susceptor 12 has an elongate shape. Each susceptor 12 is made of a thermally deformable element in the form of a bimetallic strip. The bimetallic strip comprises a first material and a second material. The coefficients of thermal expansion of the two materials are different. The material with the lower coefficient of thermal expansion is arranged towards the inside of the cavity 14 formed by the susceptor 12. The cavity 14 is formed as a hollow tubular arrangement.

The aerosol-generating article 16 is configured to be received in the cavity 14. The aerosol-generating article 16 can be inserted into the cavity 14. When the aerosol-generating article 16 is inserted into the cavity 14, the heating element 10 surrounds a portion of the aerosol-generating article 16. The portion of the aerosol-generating article 16 surrounded by the heating element 10 can be heated by means of the heating element 10.

The portion of the aerosol-generating article 16 surrounded by the heating element 10 is preferably configured as a substrate portion of the aerosol-generating article 16 comprising aerosol-forming substrate. Furthermore, a breakable capsule can be arranged in the substrate portion of the aerosol-generating article 16.

During a heating operation, the heating element 10 is deformed. The deformation is facilitated by the bimetallic strip being heated. The heating of the bimetallic strip results in a deformation of the bimetallic strip. The susceptor 12 is arranged such that the deformation is in the direction of the inside of the cavity 14. In this way, the aerosol-generating article 16 is securely held within the cavity 14 during a heating operation. Before and after the heating operation, the aerosol-generating article 16 can be easily inserted into the cavity 14 and removed from the cavity 14.

To enable insertion and removal of the aerosol-generating article 16, the inner diameter of the heating element 10 is slightly larger than the outer diameter of the aerosol-generating article 16, when the heating element 10 is not operated. During operation of the heating element 10, the heating element 10 is deformed and the inner diameter of the heating element 10 is reduced. The reduced inner diameter of the heating element 10 is slightly smaller than the outer diameter of the aerosol-generating article 16. Consequently, the heating element 10 is pressed against the aerosol-generating article 16 during the heating operation. The aerosol-generating article 16 is consequently securely held and heating efficiency is increased.

FIG. 1 further shows a power supply in the form of a battery 18 for powering the heating element 10. The supply of electrical energy from the battery 18 to the heating element 10 is controlled by control circuitry 20.

The aerosol-generating device or the heating element 10 comprises an induction coil 22. An alternating current is supplied to the induction coil 22 for generating an alternating magnetic field. The susceptor 12 is heated when subjected to this alternating magnetic field. In the embodiment shown in FIG. 1, two induction coils 22 are provided that are separated by a separator 24. The two induction coils 22 create two separate heating zones that are provided along the longitudinal axis L of the cavity 14. Thermal insulation 26 is provided between the induction coils 22 and the susceptor 12.

An air inlet 28 is provided to enable flow of ambient air into the cavity 14 for aerosol generation. The air inlet 28 is arranged adjacent a base 30 of the cavity 14 to enable airflow into the cavity 14 through or adjacent the base 30. The base 30 may comprise one or more apertures for allowing airflow through the base 30.

The aerosol-generating device comprises a distal end 32 and a proximal end 34. The opening of the cavity 14 is arranged in the proximal end 34 of the aerosol-generating device. At the opening of the cavity 14, a sealing ring 36 is provided. The sealing ring 36 is flexible. The sealing ring 36 has a funnel shape. The sealing ring 36 enables insertion of the aerosol-generating article 16. The sealing ring 36 seals the cavity 14, when the aerosol-generating article 16 is inserted into the cavity 14.

FIG. 2 shows that the heating element 10 in more detail. The heating element 10 comprises a plurality of individual susceptor 12. Each susceptor 12 is elongate. The plurality of susceptor 12 form a hollow tubular arrangement. The hollow tubular arrangement of the susceptor 12 are arranged in the cavity 14 of the aerosol-generating device. The aerosol-generating article 16 is held by the hollow tubular arrangement of the susceptor 12.

FIG. 3 shows an embodiment of the heating element 10, in which the ends of the susceptor 12 are connected with each other by means of a supporting ring 38. The supporting ring 38 can be arranged adjacent the opening of the cavity 14. The supporting ring 38 can connect the proximal end 34s of the susceptor 12.

The other ends of the susceptor 12, the distal end 32s of the susceptor 12, can be attached to the base 30.

The supporting ring 38 being arranged adjacent the opening of the cavity 14 is shown in FIG. 4.

FIG. 5 shows the deformation of the heating element 10 during a heating operation. In FIG. 5A, the heating element 10 is shown before the heating operation. In this state, the hollow tubular arrangement formed by the heating element 10 has straight side walls formed by the individual susceptor 12. In FIG. 5B, the heating element 10 is shown during operation. The heating element 10 is deformed. In more detail, the middle portion 40 of the individual susceptor 12 are deformed in the direction of the inner of the hollow tubular arrangement of the heating element 10. This action will securely hold the aerosol-generating article 16 within the cavity 14 and improve heating efficiency due to the direct contact between the heated susceptor 12 and the aerosol-generating article 16. The deformation of the heating element 10 can also be seen in FIG. 1A (no deformation of the heating element 10) and FIG. 1B (deformation of the heating element 10) and FIG. 4A (no deformation of the heating element 10) and FIG. 4B (deformation of the heating element 10).

1.-15. (canceled)

16. An aerosol-generating device, comprising:
a cavity configured to receive an aerosol-generating article comprising an aerosol-forming substrate; and
an induction heating element comprising a susceptor configured to heat,
wherein the susceptor is arranged as multiple elongate elements,
wherein the susceptor is arranged as the multiple elongate elements forming a hollow tubular arrangement with gaps between individual elongate elements,
wherein the susceptor comprises a thermally deformable element arranged in the cavity, and
wherein the thermally deformable element is configured to thermally deform during a heating operation to contact and hold the aerosol-generating article received in the cavity during a heating operation.

17. The aerosol-generating device according to claim 16, wherein the thermally deformable element is made from bimetal.

18. The aerosol-generating device according to claim 16, wherein the thermally deformable element comprises a bimetal strip.

19. The aerosol-generating device according to claim 16, wherein the susceptor is made from bimetal.

20. The aerosol-generating device according to claim 16,
wherein the susceptor further comprises a first material and a second material, and
wherein the first material has a lower coefficient of thermal expansion than the second material.

21. The aerosol-generating device according to claim 20, wherein the first and the second materials are provided as layers adjacent each other.

22. The aerosol-generating device according to claim 16, wherein the susceptor is elongate.

23. The aerosol-generating device according to claim 16, wherein the thermally deformable element of the susceptor is elongate.

24. The aerosol-generating device according to claim 16, wherein the thermally deformable element of the susceptor is arranged as the multiple elongate elements.

25. The aerosol-generating device according to claim 16, wherein the thermally deformable element of the susceptor is arranged as the multiple elongate elements forming a hollow tubular arrangement with gaps between the individual elongate elements.

26. The aerosol-generating device according to claim 16,
wherein each of the multiple elongate elements comprises a first end and an opposite second end, and
wherein one or both of each of the first ends and each of the second ends of the multiple elongate elements are connected with each other.

27. The aerosol-generating device according to claim 16,
wherein each of the multiple elongate elements comprises a first end and an opposite second end, and
wherein one or both of each of the first ends and each of the second ends of the multiple elongate elements are connected with each other via a supporting ring.

28. The aerosol-generating device according to claim 26,
wherein the first ends of the multiple elongate elements are connected with each other via a supporting ring, and
wherein the second ends of the multiple elongate elements are fixed to a base of the cavity.

29. The aerosol-generating device according to claim 28, wherein the base of the cavity is arranged at a distal end of the cavity, and the supporting ring is arranged at a proximal end of the cavity.

30. The aerosol-generating device according to claim 20, wherein the first material with the lower thermal coefficient of thermal expansion is arranged facing the cavity, and the second material is arranged facing away from the cavity.

31. A system comprising an aerosol-generating device according to claim 16 and an aerosol-generating article comprising an aerosol-forming substrate.

32. The system according to claim 31,
wherein the thermally deformable element of the susceptor is arranged to enable insertion of the aerosol-generating article into the cavity, when the heating element is not operated, and
wherein the thermally deformable element of the susceptor is configured to thermally deform and thereby contact and hold the aerosol-generating article in the cavity, when the heating element is operated.

33. The system according to claim 31,
wherein the aerosol-generating article comprises a capsule comprising an active agent, and
wherein the capsule is arranged adjacent the thermally deformable element when the aerosol-generating article is received in the cavity such that the capsule is ruptured and the active agent released when the heating element is operated and the thermally deformable element of the susceptor is thermally deformed.
